(19) United States
(12) Patent Application Publication
(10) Pub. No.: US 2008/0113661 A1
(43) Pub. Date: May 15, 2008

(54) Mobile device service provider management

(75) Inventor: Mikko Repka, Oulu (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/600,518

(22) Filed: Nov. 15, 2006

(51) Int. Cl. H04M 3/00

(52) U.S. Cl. 455/418

(57) ABSTRACT

A method is provided that provides a user with additional options for managing service providers for mobile devices that wirelessly connect to service providers. The method includes: in response to detecting a plurality of signals corresponding to a plurality of service providers to which a mobile electronic device may wirelessly connect, providing a user with at least one option to assist in selecting a service provider of the plurality of service providers; and in response to a user input, selecting a service provider of the plurality of service providers.

### TECHNICAL FIELD

The teachings in accordance with the exemplary embodiments of this invention relate generally to mobile electronic devices and, more specifically, relate to wireless service provider selection for mobile electronic devices.

### BACKGROUND

In forming a wireless connection, mobile electronic devices (e.g. mobile devices) rely on a service provider to supply a network connection. Through the network connection, the mobile device can communicate with other electronic devices, networks and the Internet. For wireless connections, conventional mobile devices select and utilize a service provider based on a set of rules. There are three sets of service provider rules available to conventional mobile devices: automatic, manual and default.

If the automatic setting is enabled or selected, the mobile device utilizes the service provider having the strongest signal. For example, if service provider A is currently being used but the signal strength for service provider B becomes stronger than the signal strength for service provider A, the mobile device will switch to service provider B.

Under the manual setting, the mobile device performs a network scan. The device then displays available service providers from which the user manually selects one for the device to use. The mobile device may or may not show the associated signal strength when displaying available service providers.

With the default setting, a home (e.g. native) service provider is specified, for example, by a SIM (Subscriber Identity Module) card in a cellular phone.

### SUMMARY

In an exemplary aspect of the invention, a method is provided that provides a user with additional options for managing service providers for mobile devices that wirelessly connect to service providers. The method includes: in response to detecting a plurality of signals corresponding to a plurality of service providers to which a mobile electronic device may wirelessly connect, providing a user with at least one option to assist in selecting a service provider of the plurality of service providers; and in response to a user input, selecting a service provider of the plurality of service providers.

In another exemplary aspect of the invention, another method is provided. The method includes: in response to detecting a plurality of signals corresponding to a plurality of service providers, a mobile electronic device accessing a user-specified at least one rule controlling to which service provider of the plurality of service providers the mobile electronic device may wirelessly connect; using at least the user-specified at least one rule, selecting a service provider of the plurality of service providers; and providing a user with a dialogue. The dialogue enables the user to confirm or reject the selected service provider.

In a further exemplary aspect of the invention, an electronic device is provided. The electronic device includes at least one data processor; at least one memory coupled to the at least one data processor; a transceiver coupled to the at least one data processor; a display device coupled to the at least one data processor; and an input device coupled to the at least one data processor. The at least one data processor, using the transceiver, is operable to detect signals corresponding to service providers. The at least one data processor, using the display device, in response to detecting a plurality of signals corresponding to a plurality of service providers to which the mobile electronic device may wirelessly connect, is operable to display to a user at least one option to assist in selecting a service provider of the plurality of service providers. The at least one data processor, in response to a user input received from the input device, is operable to initiate a wireless connection to a selected service provider of the plurality of service providers.

In another exemplary aspect of the invention, a computer program product is provided. The computer program product includes program instructions embodied on a tangible computer-readable medium. Execution of the program instructions results in operations including: in response to detecting a plurality of signals corresponding to a plurality of service providers to which a mobile electronic device may wirelessly connect, providing a user with at least one option to assist in selecting a service provider of the plurality of service providers; and in response to a user input, selecting a service provider of the plurality of service providers.

### BRIEF DESCRIPTION OF THE DRAWINGS:

The foregoing and other aspects of embodiments of this invention are made more evident in the following Detailed Description, when read in conjunction with the attached Drawing Figures, wherein:

FIG. 1 illustrates a simplified block diagram showing one or more electronic devices that are suitable for use in practicing the exemplary embodiments of this invention;

FIG. 2 depicts a flowchart illustrating one non-limiting example of a method to practice in conjunction with the exemplary embodiments of this invention;

FIG. 3 depicts a flowchart illustrating another non-limiting example of a method for practicing the exemplary embodiments of this invention;

FIG. 4 shows an exemplary system having four service providers and a mobile device, wherein the mobile device employs the exemplary embodiments of this invention;

FIGS. 5 and 6 illustrate another exemplary system having two service providers and a mobile device, wherein the mobile device employs the exemplary embodiments of this invention;

FIG. 7 shows a flowchart depicting another non-limiting example of a method for practicing the exemplary embodiments of the invention; and

FIG. 8 illustrates a flowchart showing another non-limiting example of a method for practicing the exemplary embodiments of the invention.

### DETAILED DESCRIPTION

There are a few drawbacks to the service provider options currently available in conventional mobile devices. If the user is in an area that has several strong signals, the device may frequently switch service providers. Currently, some service providers send a greeting SMS (Short Message Service) when a user switches into their service. If the mobile device automatically switches service providers on a frequent basis, the user may receive multiple greeting SMS messages.

Another problem might occur when the mobile device selects a service provider that is not optimal for the user. For example, if a user is using the mobile device in country A near the border between countries A and B, the user may prefer service providers in country A rather than service providers in country B which are more expensive. However, under conventional settings and options, the mobile device may automatically select service providers in country B when those service providers have a stronger signal. This can lead to increased costs for the user. Furthermore, the user may not even be aware that the mobile device has switched to a service provider in country B as some mobile devices do not inform the user when switching service providers.

Thus, it would be beneficial to provide a user with additional options for managing service providers for mobile devices that wirelessly connect to service providers. The exemplary embodiments of this invention provide methods, an electronic device and a computer program product that provide a user with additional options for managing service providers. The exemplary embodiments of this invention enable and accomplish such management as further explained below.

Various aspects of system selection have been previously considered, such as in commonly-assigned: U.S. Pat. No. 5,903,832, U.S. patent application Ser. No. 11/107,495 and U.S. patent application Ser. No. 11/403,443.

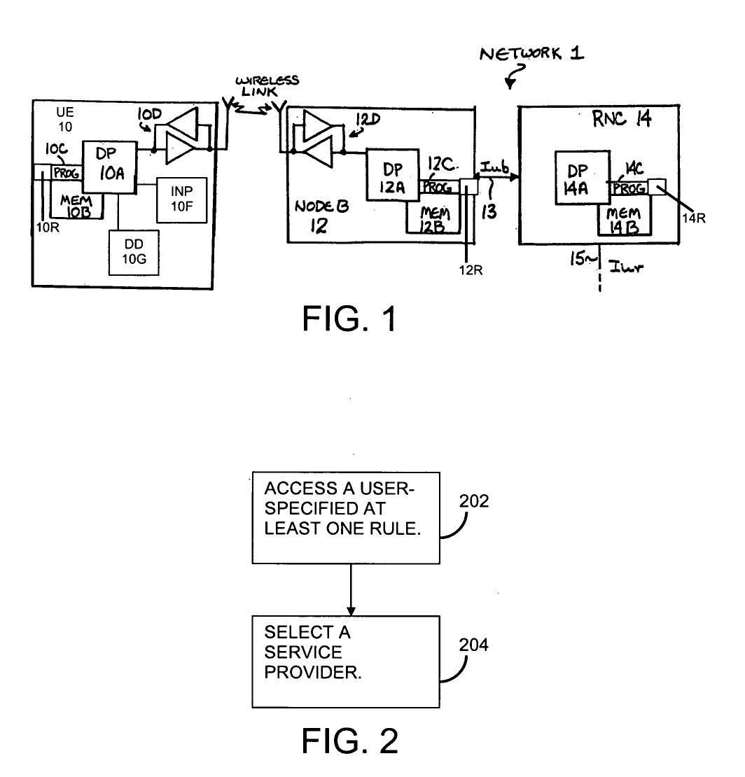

Reference is made first to FIG. 1 for illustrating a simplified block diagram showing one or more electronic devices that are suitable for use in practicing the exemplary embodiments of this invention. In FIG. 1, a wireless network 1 is adapted for communication with a user equipment (UE) 10 via a Node B (base station) 12. The network 1 may include a radio network controller (RNC) 14, which may be referred to as a serving RNC (SRNC). The UE 10 includes a data processor (DP) 10A coupled to a memory (MEM) 10B, wherein the MEM 10B stores a program (PROG) 10C, and the UE 10 further includes a suitable RF transceiver 10D (having a transmitter (TX) and a receiver (RX)) coupled to the DP 10A for bidirectional wireless communications with the Node B 12, which also includes a DP 12A, a MEM 12B that stores a PROG 12C, and a suitable RF transceiver 12D. The Node B 12 is coupled via a data path 13 (Iub) to the RNC 14 that also includes a DP 14A and a MEM 14B storing an associated PROG 14C. The RNC 14 may be coupled to another RNC (not shown) by another data path 15 (Iur). At least one of the PROGs 10C, 12C and 14C is assumed to include program instructions 10R, 12R, 14R that, when executed by the associated DP, enable the electronic device to operate in accordance with the exemplary embodiments of this invention, as will be discussed below in greater detail. As a non-limiting example, the DP 10A, in conjunction with at least the transceiver 10D and PROG 10C, may be operable to detect a signal corresponding to a service provider. As a further non-limiting example, the DP 10A in conjunction with the DD 10G, may be operable to display information to a user, such as options to select or information relating to detected service providers, as non-limiting examples. In other embodiments, the UE 10 also includes a user input (INP) 10F coupled to the DP 10 A. As a non-limiting examples, the UE 10 may comprise the mobile electronic device (e.g. mobile device) referenced elsewhere herein. As a non-limiting example, the Node B 12 and/or RNC 14 may comprise the service provider referenced elsewhere herein. In other embodiments, the UE 10 also includes a display device (DD) 10G coupled to the DP 10A.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by the DP 10A of the UE 10 and other DPs such as the DP 12A, or by hardware, or by a combination of software and hardware.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

Exemplary embodiments of the invention may be implemented as a computer program product. As non-limiting examples, the computer program product may reside as a program in one or more of MEMs 10B, 12B and 14B. As a further non-limiting example, the computer program product may reside on a removable memory, such as a compact disc (CD) or a digital video disc (DVD), as non-limiting examples.

In some exemplary embodiments of this invention, a method is provided wherein a user-specified at least one rule is accessed. The at least one rule controls to which service provider of a plurality of service providers a mobile device may wirelessly connect. Using the user-specified at least one rule, a service provider of the plurality of service providers is selected. The mobile device can wirelessly connect to the selected service provider. In such a manner, a user is better able to control which service providers the mobile device utilizes and/or the order of or preference for selected service providers.

FIG. 2 depicts a flowchart illustrating one non-limiting example of a method to practice in conjunction with the exemplary embodiments of this invention. In box 202, a user-specified at least one rule is accessed. The at least one rule controls to which service provider of a plurality of service providers a mobile device may wirelessly connect. In box 204, using the user-specified at least one rule, a service provider of the plurality of service providers is selected. The mobile device can wirelessly connect to the selected service provider.

The user-specified at least one rule may comprise any of a number of different options and/or rules. As non-limiting examples, the at least one rule may comprise one or more of the following: a prioritized list of service providers, blocked service providers (at least one service provider to which the mobile device may not wirelessly connect, for example), a signal strength at which the mobile device switches to a different service provider (a threshold signal strength where if the signal strength falls below the threshold value another service provider having a signal strength above the threshold value is used instead, for example), a signal strength at which the mobile device switches to a different type of technology (an advanced technology versus an ordinary mobile technology, as discussed below, for example), a data speed (a bit rate, for example) directing whether the mobile device should or should not connect to a certain service provider, one or more desired services (as further explained below), and a cost or expense value associated with the service providers.

If a signal strength is employed, the mobile device may determine said signal strength using components located on, within or associated with the mobile device, as non-limiting examples. If a cost or expense value is utilized, the mobile device may obtain the value from a database, internal or external to the mobile device, or from a service, as non-limiting examples.

The selection of the service provider may be performed by the mobile device or by any other electronic device in communication with the mobile device.

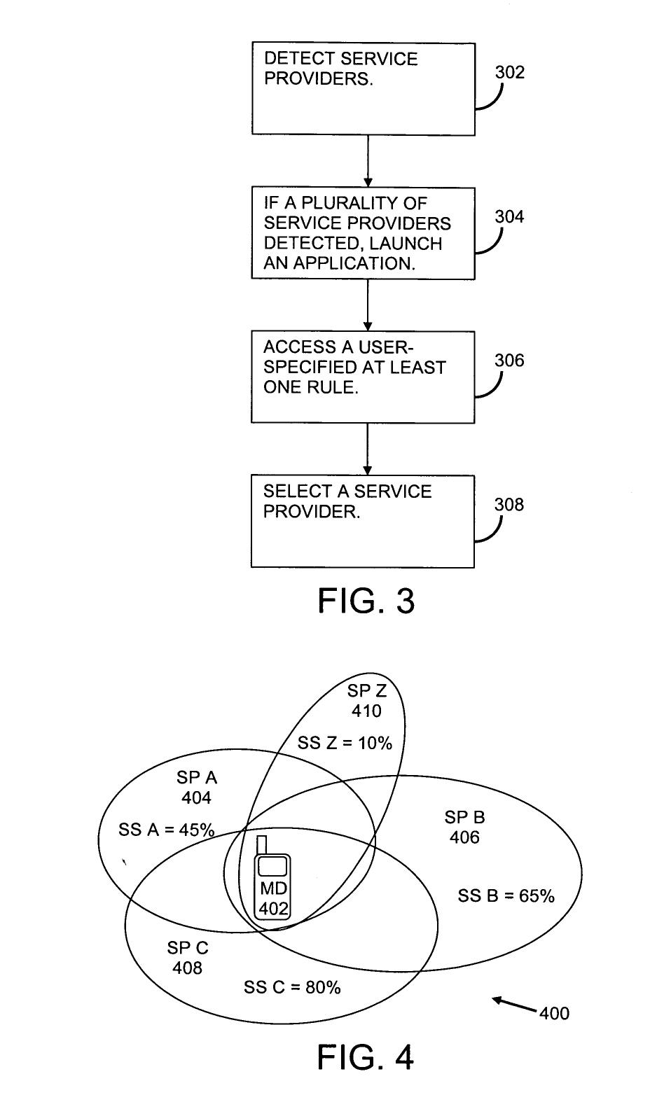

In other exemplary embodiments of this invention, another method is provided. FIG. 3 depicts a flowchart illustrating a non-limiting example of another method for practicing the exemplary embodiments of this invention. The method includes the following steps. In box 302, a mobile device detects service providers. In box 304, in response to detecting a plurality of service providers, the mobile device launches an application. In box 306, the application accesses a user-specified at least one rule. The at least one rule controls to which service provider of the plurality of service providers the mobile device may wirelessly connect. In box 308, the user-specified at least one rule is used to select a service provider of the plurality of service providers. The mobile device can wirelessly connect to the selected service provider. In further exemplary embodiments, the application enables the user to specify the user-specified at least one rule. The application may comprise a program, as a non-limiting example.

In other exemplary embodiments, the rule may be specified by using a series of pull-down menus and user inputs. In such a manner, a user may be able to designate various combinations of preferences.

FIG. 4 shows an exemplary system 400 having four service providers 404, 406, 408 and 410 and a mobile device (MD) 402. The MD 402 employs the exemplary embodiments of this invention. The four service providers are service provider (SP) A 404, SP B 406, SP C 408 and SP Z 410. The coverage for each service provider is indicated by the corresponding oval. As is apparent, the MD 402 potentially could wirelessly connect to any one of the four SPs, 404, 406, 408 or 410. A non-limiting example of the MD 402 is the UE 10 of FIG. 1. A non-limiting example of the SPs 404, 406, 408 and 410 is the Node B 12 of FIG. 1.

For the below examples, assume that for the MD 402 the signal strength of SP A (SS A) is 45%. Assume that the signal strength of SP B (SS B) is 65%. Assume that the signal strength of SP C (SS C) is 80%. Assume that the signal strength of SP Z (SS Z) is 10%. The specific service provider selected by the MD 402 would depend on the set of rules (e.g. the user-specified at least one rule) accessed by the MD 402.

For example 1, the set of rules includes the following: If the signal strength falls below 15% then switch service providers to one having a signal strength greater than 15%. Follow a prioritized list of service providers, from most preferred to least preferred, of: SP A 404, SP B 406, SP C 408 and SP Z 410, where the selected service provider is the highest service provider on the prioritized list that is different from the currently used service provider.

### EXAMPLE 1

Assume that the MD 402 is initially connected to SP Z 410 and the signal strength drops to the indicated SS Z of 10%. In following the set of rules, the MD 402 would switch to SP A 404 since the signal strength of the current service provider (SS Z) has fallen below 15%, SP A 404 is the highest service provider on the prioritized list, SP A 404 is not the currently used service provider (i.e. SP A 404 is different from the currently used service provider, SP Z 410), and SS A is greater than 15%.

For example 2, the set of rules includes the following: If the signal strength falls below 15% then switch service providers to one having a signal strength greater than 15%. Select a different service provider that has the greatest signal strength. Do not select SP C 408 (that is, SP C 408 is blocked).

### EXAMPLE 2

Assume that the MD 402 is initially connected to SP Z 410 and the signal strength drops to the indicated SS Z of 10%. In following the set of rules, the MD 402 would switch to SP B 406 because the signal strength of the current service provider (SP Z 410) has fallen below 15%. The service provider with the highest signal strength is SP C 408 with a SS C of 80% except SP C 408 may not be selected. Thus, SP B 406, having the highest signal strength of the remaining service providers (i.e. SP A 404 and SP B 406), would be selected.

For example 3, the set of rules includes the following: If the signal strength falls below 15% then switch service providers to one having a signal strength greater than 15%. Select a different service provider that has the greatest signal strength. Switch to the same type of technology (see below for examples) if possible. If a different service provider for the same type of technology is unavailable but a service provider for a different type of technology is available, inform the user that the different type of technology is available.

### EXAMPLE 3

Assume that the MD 402 is initially connected to SP Z 410 and the signal strength drops to the indicated SS Z of 10%. Furthermore, assume that SP Z 410 is providing a first mobile technology and the other service providers (i.e. SP A 404, SP B 406, SP C 408) can provide a second mobile technology. A service provider for the same type of technology (the first mobile technology) is unavailable. However, a service provider for a different type of technology (a second mobile technology) is available, namely SP A 404, SP B 406 or SP C 408. The MD 402 would inform the user that a second mobile technology is available instead of the first mobile technology. In further embodiments, the MD 402 would switch to SP C 408 since SP C 408 has the highest signal strength of the available service providers.

Additional non-limiting examples of rules that maybe employed include: Do not select a connection slower than 100 bytes/sec. without confirmation from the user. Select the least expensive available service provider. Do not select a service provider that costs more than $1.50 per minute.

As noted above, in some exemplary embodiments, a user whose mobile device is currently using a first mobile technology is informed when the signal strength of the first technology falls below a certain signal strength (e.g. a threshold value) and a second mobile technology is available for the mobile device to utilize. Similar notification may also be employed for other criteria, such as when a first technology becomes unavailable and a second technology is available for the mobile device to use, as a non-limiting example.

As used herein, service refers to an activity the mobile device may engage in. As non-limiting examples, service may refer to video calls, video streaming, audio streaming, network gaming, accessing the internet or accessing e-mail. As noted herein, a desired service or services may be used to establish a desired rule or to select a service provider, of a plurality of service providers, to which the mobile device may wirelessly connect.

The first and second technologies utilized herein generally refer to different telecommunications technologies. The first and second technologies are considered to be two different technologies with the first technology having a faster data speed or being an improvement on the second technology. For convenience, the first technology is also referred to herein as an advanced technology and the second technology is also referred to herein as an ordinary mobile technology.

As employed herein, advanced technology (that is, the first technology) refers to technologies that enable fast data speeds. Fast data speeds refers not only to fast file transfers but also to services in which a fast data speed may be a critical enabler. For example, slower connections may prevent the use of certain services or make such services inconvenient or difficult. Non-limiting examples of services in which a fast data speed may be a critical enabler include video calls, video and/or audio streaming and network gaming. Non-limiting examples of advanced technologies include WiMAX, WLAN, other wireless broadband services and technologies, including third generation mobile communications (3G), WCDMA and future extensions to the current 3G, such as 3.9G. Non-limiting examples of third generation mobile communication technologies include W-CDMA, CDMA2000, TD-CDMA and UMTS.

As utilized herein, ordinary mobile technology (that is, the second technology) refers to technologies that enable relatively slow data speeds. This category includes services and technologies directed to operations which generally do not require a fast data speed, such as phone calls, “simple” web-browsing, and other less content-heavy uses, as non-limiting examples. This category also includes second generation mobile communications (2G), as a non-limiting example. Non-limiting examples of ordinary mobile technologies include CDMA, TDMA, FDMA, and OFDM. Non-limiting examples of second generation mobile communication (2G) technologies include GSM, CDMA and D-Amps.

As one example of a method for switching types of technologies (e.g. performing an inter-technology handoff) please refer to U.S. Patent Publication No. 2004/0090937 entitled “Method and Apparatus for Performing Inter-Technology Handoff from WLAN to Cellular Network” by Chaskar et al.

With regards to such exemplary embodiments, the mobile device includes accessibility for both advanced technologies and ordinary mobile technologies. This accessibility may be enabled by different components within the mobile device (e.g. different integrated circuits or chips) or by a single component handling both types of technologies.

For example, consider a mobile device having WiMAX capabilities in addition to ordinary mobile service. The mobile device may utilize WiMAX for data transfers or for making VOIP calls (Skype, for example). However, it is likely that the WiMAX coverage will not be as large or consistent as the coverage for ordinary mobile technologies. Under this exemplary embodiment, a user would be notified when calls are handed off as between WiMAX and the ordinary mobile technology. This may be desirable since the charges for the two different technologies are likely different with one technology potentially being more expensive than the other technology. In another embodiment, the mobile device would switch to the ordinary mobile technology. In a further embodiment, in response to a user input, the mobile device would switch to the ordinary mobile technology.

In accordance with the exemplary embodiments of this invention, a user could specify a series of rules for the mobile device to employ when selecting a service provider. Consider the following as a further non-limiting example of such a set of rules: “Inform the user when the WiMAX signal strength drops below 30% and automatically switch the network used to a WCDMA network when the signal strength drops below 5%. Switch back to WiMAX when the signal strength is above 10%.” In such a manner, a user can readily manage the service providers selected and types of services used when the mobile device wirelessly connects to a service provider.

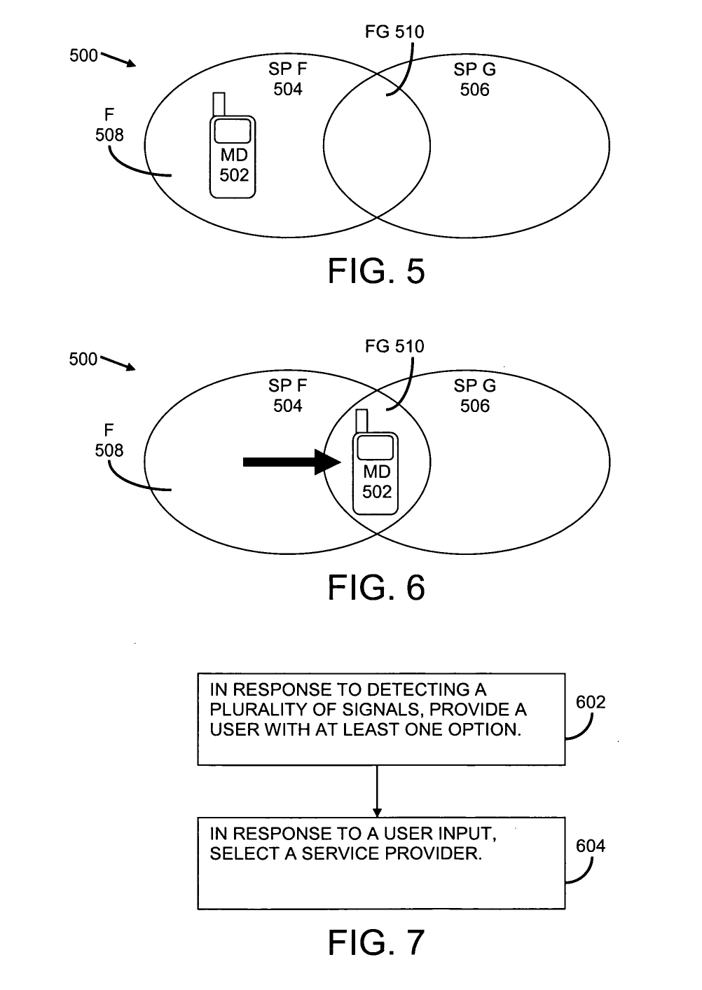

FIGS. 5 and 6 illustrate another exemplary system 500 having two service providers (SPs or SP in the singular) 504, 506 and a mobile device (MD) 502, wherein the MD 502 employs the exemplary embodiments of this invention. The two SPs are SP F 504 and SP G 506. The coverage for each SP is indicated by the corresponding oval. For example, region F (F) 508 refers to a portion of the system 500 in which only a wireless connection to SP F 504 is available while region FG (FG) 510 refers to a portion of the system 500 in which wireless connections are available to both SP F 504 and SP G 506.

In FIG. 5, the MD 502 is in region F 508 and, thus, may only wirelessly connect to SP F 504. In FIG. 6, the MD 502 has moved into region FG 510 and, thus, wireless connections to both SP F 504 and SP G 506 are available. Upon detecting a plurality of service providers, or otherwise being informed of a plurality of service providers, the MD 502 may then employ a method for practicing the exemplary embodiments of this invention, such as the method shown in FIGS. 2, 3, 7 or 8, as non-limiting examples. Being informed of a plurality of service providers may include accessing a database of service provider coverage and correlating that database with the approximate location of the mobile device, as a non-limiting example.

FIG. 7 shows a flowchart depicting another non-limiting example of a method for practicing the exemplary embodiments of the invention. In box 602, in response to detecting a plurality of signals corresponding to a plurality of service providers to which a mobile electronic device may wirelessly connect, a user is provided with at least one option to assist in selecting a service provider of the plurality of service providers. In box 604, in response to a user input, a service provider of the plurality of service providers is selected.

In other embodiments, the plurality of signals detected may satisfy at least one initial condition. The initial condition may include a threshold power level or a desired type of service or technology, as non-limiting examples. In further embodiments, providing the user with at least one option may involve launching an application. In other embodiments, the at least one option may include: a prioritized list of all or a portion of the plurality of service providers or at least one user-designated service provider to which the mobile electronic device may not wirelessly connect, as non-limiting examples.

In other embodiments, the at least one option is a first at least one option, the user input is a first user input, the selected service provider is a first selected service provider and the method further includes the steps of: attempting to connect to the first selected service provider; in response to a failure to connect to the first selected service provider, providing the user with a second at least one option to assist in selecting a second service provider of the plurality of service providers; and in response to a second user input, selecting a second service provider of the plurality of service providers. These additional steps may repeated, for all of the service providers in the plurality of service providers, upon successive failed connection attempts to individual service providers of the plurality of service providers. In such a manner, in response to one or more connection failures, the user is provided with options to assist in selecting another service provider.

In other embodiments, the at least one option may include information for at least one service provider of the plurality of service providers. The information may one or more of the following, as non-limiting examples: cost information, at least one available service, at least one available technology, a geographic location or a name of the at least one service provider. In further embodiments, the at least one option may enable the user to specify at least one rule controlling to which service provider of the plurality of service providers the mobile electronic device may wirelessly connect. In other embodiments, the at least one option may use pull-down menus. In further embodiments, the at least one option may have a plurality of selectable options to assemble a Boolean expression of a rule controlling to which service provider of the plurality of service providers the mobile electronic device may or may not wirelessly connect. The plurality of selectable options could enable a user to specify a rule such as those in Examples 1, 2 and 3 above, as non-limiting examples.

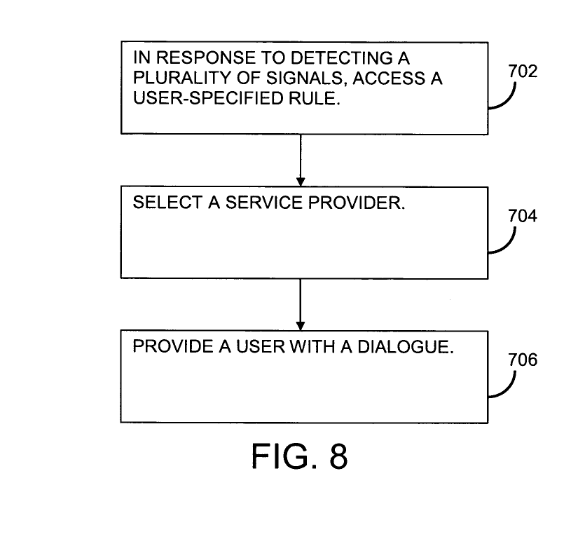

FIG. 8 illustrates a flowchart showing another non-limiting example of a method for practicing the exemplary embodiments of the invention. In box 702, in response to detecting a plurality of signals corresponding to a plurality of service providers, a mobile electronic device accesses a user-specified at least one rule controlling to which service provider of the plurality of service providers the mobile electronic device may wirelessly connect. In box 704, using at least the user-specified at least one rule, a service provider of the plurality of service providers is selected. In box 706, a user is provided with a dialogue. The dialogue enables the user to confirm or reject the selected service provider.

Other embodiments of the method depicted in FIG. 8 may incorporate the other exemplary embodiments, aspects or potential other embodiments thereof, as described above. In one other embodiment of the method illustrated in FIG. 8, selecting a service provider is performed automatically without interference from the user.

The exemplary embodiments of this invention maybe implemented in the form of a computer program product having program instructions embodied on a tangible computer-readable medium. In general, the various embodiments maybe implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
in response to detecting a plurality of signals corresponding to a plurality of service providers to which a mobile electronic device may wirelessly connect, providing a user with at least one option to assist in selecting a service provider of the plurality of service providers; and
in response to a user input, selecting a service provider of the plurality of service providers.

2. The method of claim 1, wherein the plurality of signals detected satisfy at least one initial condition.

3. The method of claim 2, wherein the at least one initial condition comprises a threshold power level.

4. The method of claim 1, wherein the at least one option comprises a first at least one option, wherein the user input comprises a first user input and wherein the selected service provider comprises a first selected service provider, the method further comprising:
attempting to connect to the first selected service provider;
in response to a failure to connect to the first selected service provider, providing the user with a second at least one option to assist in selecting a second service provider of the plurality of service providers; and
in response to a second user input, selecting a second service provider of the plurality of service providers.

5. The method of claim 1, wherein providing the user with the at least one option comprises launching an application.

6. The method of claim 1, wherein the at least one option comprises a prioritized list comprising at least a portion of the plurality of service providers.

7. The method of claim 1, wherein the at least one option comprises at least one user-designated service provider to which the mobile electronic device may not wirelessly connect.

8. The method of claim 1, wherein the at least one option comprises information for at least one service provider of the plurality of service providers.

9. The method of claim 8, wherein the information comprises cost information.

10. The method of claim 8, wherein the information comprises at least one available service.

11. The method of claim 8, wherein the information comprises at least one available technology.

12. The method of claim 8, wherein the information comprises a geographic location.

13. The method of claim 8, wherein the information comprises a name of the at least one service provider.

14. A method comprising:
in response to detecting a plurality of signals corresponding to a plurality of service providers, a mobile electronic device accessing a user-specified at least one rule controlling to which service provider of the plurality of service providers the mobile electronic device may wirelessly connect;
selecting, using at least the user-specified at least one rule, a service provider of the plurality of service providers; and
providing a user with a dialogue, wherein the dialogue enables the user to confirm or reject the selected service provider.

15. The method of claim 14, wherein the user-specified at least one rule comprises a prioritized list comprising at least a portion of the plurality of service providers and wherein selecting a service provider comprises selecting a highest service provider on the prioritized list.

16. The method of claim 14, wherein selecting a service provider is performed automatically without interference from the user.

17. The method of claim 14, wherein the plurality of signals detected satisfy at least one initial condition.

18. The method of claim 14, wherein the selected service provider comprises a first selected service provider and wherein the dialogue comprises a first dialogue, the method further comprising:
in response to the user confirming the first selected service provider, attempting to connect to the first selected service provider;
in response to a failure to connect to the first selected service provider, selecting, using at least the user-specified at least one rule, a second service provider of the plurality of service providers; and
providing a user with a second dialogue, wherein the second dialogue enables the user to confirm or reject the second selected service provider.

19. The method of claim 14, wherein accessing the user-specified at least one rule comprises launching an application.

20. The method of claim 14, wherein the user-specified at least one rule comprises at least one user-designated service provider to which the mobile electronic device may not wirelessly connect.

21. The method of claim 14, wherein the dialogue comprises information for at least one service provider of the plurality of service providers.

22. A computer program product comprising program instructions embodied on a tangible computer-readable medium, execution of the program instructions resulting in operations comprising:
in response to detecting a plurality of signals corresponding to a plurality of service providers to which a mobile electronic device may wirelessly connect, providing a user with at least one option to assist in selecting a service provider of the plurality of service providers; and
in response to a user input, selecting a service provider of the plurality of service providers.

23. The computer program product of claim 22, wherein the plurality of signals detected satisfy at least one initial condition.

24. The computer program product of claim 22, wherein the at least one option comprises a first at least one option, wherein the user input comprises a first user input and wherein the selected service provider comprises a first selected service provider, the execution of the program instructions resulting in operations further comprising:
attempting to connect to the first selected service provider;
in response to a failure to connect to the first selected service provider, providing the user with a second at least one option to assist in selecting a second service provider of the plurality of service providers; and
in response to a second user input, selecting a second service provider of the plurality of service providers.

25. The computer program product of claim 22, wherein providing the user with the at least one option comprises launching an application.

26. The computer program product of claim 22, wherein the at least one option comprises a prioritized list comprising at least a portion of the plurality of service providers.

27. The computer program product of claim 22, wherein the at least one option comprises at least one user-designated service provider to which the mobile electronic device may not wirelessly connect.

28. The computer program product of claim 22, wherein the at least one option comprises information for at least one service provider of the plurality of service providers.

29. A mobile electronic device comprising:
at least one data processor;
at least one memory coupled to the at least one data processor;
a transceiver coupled to the at least one data processor, wherein the at least one data processor, using the transceiver, is operable to detect signals corresponding to service providers;
a display device coupled to the at least one data processor, wherein the at least one data processor, using the display device, in response to detecting a plurality of signals corresponding to a plurality of service providers to which the mobile electronic device may wirelessly connect, is operable to display to a user at least one option to assist in selecting a service provider of the plurality of service providers; and
an input device coupled to the at least one data processor, wherein the at least one data processor, in response to a user input received from the input device, is operable to initiate a wireless connection to a selected service provider of the plurality of service providers.

30. The mobile electronic device of claim 29, wherein the mobile electronic device comprises a cellular telephone.

31. The mobile electronic device of claim 29, wherein the plurality of signals detected satisfy at least one initial condition.

32. The mobile electronic device of claim 31, wherein the at least one initial condition comprises a threshold power level.

33. The mobile electronic device of claim 29, wherein the at least one option comprises a first at least one option, wherein the user input comprises a first user input, wherein the selected service provider comprises a first selected service provider, wherein the at least one data processor is further operable to perform operations comprising:
in response to a failure to initiate a wireless connection with the first selected service provider, using the display device, displaying to the user a second at least one option to assist in selecting a second service provider of the plurality of service providers; and
in response to a second user input received from the input device, initiating a wireless connection with a second selected service provider of the plurality of service providers.

34. The mobile electronic device of claim 29, wherein displaying to the user the at least one option comprises launching an application.

35. The mobile electronic device of claim 29, wherein the at least one option comprises a prioritized list comprising at least a portion of the plurality of service providers.

36. The mobile electronic device of claim 29, wherein the at least one option comprises at least one user-designated service provider to which the mobile electronic device may not wirelessly connect.

37. The mobile electronic device of claim 29, wherein the at least one option comprises information for at least one service provider of the plurality of service providers.

38. The mobile electronic device of claim 37, wherein the information comprises a name of the at least one service provider.

39. The mobile electronic device of claim 37, wherein the information comprises cost information.

40. A mobile electronic device comprising:
at least one means for processing;
at least one means for storage coupled to the at least one means for processing;
a means for transmitting and receiving signals coupled to the at least one means for processing, wherein the at least one means for processing, using the means for transmitting and receiving signals, is operable to detect signals corresponding to service providers;
a means for displaying coupled to the at least one means for processing, wherein the at least one means for processing, using the means for displaying, in response to detecting a plurality of signals corresponding to a plurality of service providers to which the mobile electronic device may wirelessly connect, is operable to display to a user at least one option to assist in selecting a service provider of the plurality of service providers; and
a means for input coupled to the at least one means for processing, wherein the at least one means for processing, in response to a user input received from the means for input, is operable to initiate a wireless connection to a selected service provider of the plurality of service providers.

41. The mobile electronic device of claim 40, wherein the at least one option comprises a first at least one option, wherein the user input comprises a first user input, wherein the selected service provider comprises a first selected service provider, wherein the at least one means for processing is further operable to perform operations comprising:
in response to a failure to initiate a wireless connection with the first selected service provider, using the means for display, displaying to the user a second at least one option to assist in selecting a second service provider of the plurality of service providers; and
in response to a second user input received from the means for input, initiating a wireless connection with a second selected service provider of the plurality of service providers.

42. The mobile electronic device of claim 40, wherein the mobile electronic device comprises a cellular telephone.
